(19) United States
(12) Patent Application Publication
(10) Pub. No.: US 2011/0087413 A1
(43) Pub. Date: Apr. 14, 2011

(54) TOW BRAKE

(75) Inventors: Eugene McCrickard, Franklin, TN (US); John P. DeConti, Bristol, CT (US)

(73) Assignee: D-BRAKE, LLC, New Britain, CT (US)

(21) Appl. No.: 12/578,130

(22) Filed: Oct. 13, 2009

(51) Int. Cl. B60T 8/32; B60T 7/20

(52) U.S. Cl. 701/70; 188/112 R

(57) ABSTRACT

A tow brake includes a housing, an actuator mechanism mounted within the housing with the actuator mechanism including an actuator member, a towed vehicle attachment member operatively coupled to the actuator member, a controller operatively connected to the actuator mechanism, and an acceleration sensor operatively coupled to the controller, the acceleration sensor being configured and disposed to detect deceleration forces of a towing vehicle, wherein the controller is configured and disposed to selectively activate the actuator mechanism to apply a force to the vehicle attachment member that is proportional to the deceleration forces of the towing vehicle.

### BACKGROUND

The subject matter disclosed herein relates to the art of tow brakes and, more particularly, to an all electric proportional tow brake.

When towing one vehicle with another, often times a remote braking system is required in the towed vehicle. Remote braking systems or tow brakes are employed to ensure that a towed vehicle slows when an associated towing vehicle initiates a braking action. Tow brakes take on a wide variety of forms that include complicated systems that are integrated into the towed vehicle to more simple or drop in systems that are easy to connect and remove as necessary. When in use, some tow brakes sense decelerations of the towed vehicle. In response to the sensed decelerations, the tow brake slows the vehicle being towed so that forces on any connecting linkages, such as a tow bar, that connect the vehicle being towed with the towing vehicle, remain substantially neutral.

To sense deceleration, most existing tow brakes rely upon pendulum units, mercury switches, digital controllers, and connections to the towing vehicle's brake light system. Pendulum units rely upon a pivoting member that swings into contact with a micro switch in response to deceleration forces. Such systems are slow to respond and cannot detect an amount of braking force applied in the towing vehicle. Digital controllers detect that a towing vehicle's brakes are applied. These systems are also slow to respond and cannot detect a magnitude of any deceleration force. In any event, once the deceleration is detected, an actuator mechanism, in the form of an electrical actuator or pneumatic actuator applies a force to the towed vehicle brakes. Solenoid type actuators have a high amperage draw to provide the necessary energy to apply a vehicle's brakes. The high amperage draw results in high coil temperature, which, in turn, result in less force output. Pneumatic actuators rely on an air cylinder that has a finite air supply for the operating energy. After a few uses, the air supply is no longer sufficient to apply the brakes. When the air supply is low, the air compressor must run for long periods. Operating the compressor for long periods results in low battery power in the towed vehicle.

### BRIEF DESCRIPTION

According to an exemplary embodiment, a tow brake includes a housing, an actuator mechanism mounted within the housing with the actuator mechanism including an actuator member, a towed vehicle attachment member operatively coupled to the actuator member, a controller operatively connected to the actuator mechanism, and an acceleration sensor operatively coupled to the controller, the acceleration sensor being configured and disposed to detect deceleration forces of a towing vehicle, wherein the controller is configured and disposed to selectively activate the actuator mechanism to apply a force to the vehicle attachment member that is proportional to the deceleration forces of the towing vehicle.

According to another exemplary embodiment, a method of braking a towed vehicle based on acceleration forces of a towing vehicle includes detecting a deceleration force of a towing vehicle, determining a rate of deceleration of the towing vehicle, and activating an actuator mechanism to cause an actuation member to apply a braking force proportional to the rate of deceleration of the towing vehicle to a brake pedal in the towed vehicle.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a tow brake system in accordance with an exemplary embodiment; and

FIG. 2 is an exploded view of a tow brake portion of the tow brake system.

The detailed description explains embodiments of the invention, together with advantages and features, by way of example with reference to the drawings.

### DETAILED DESCRIPTION

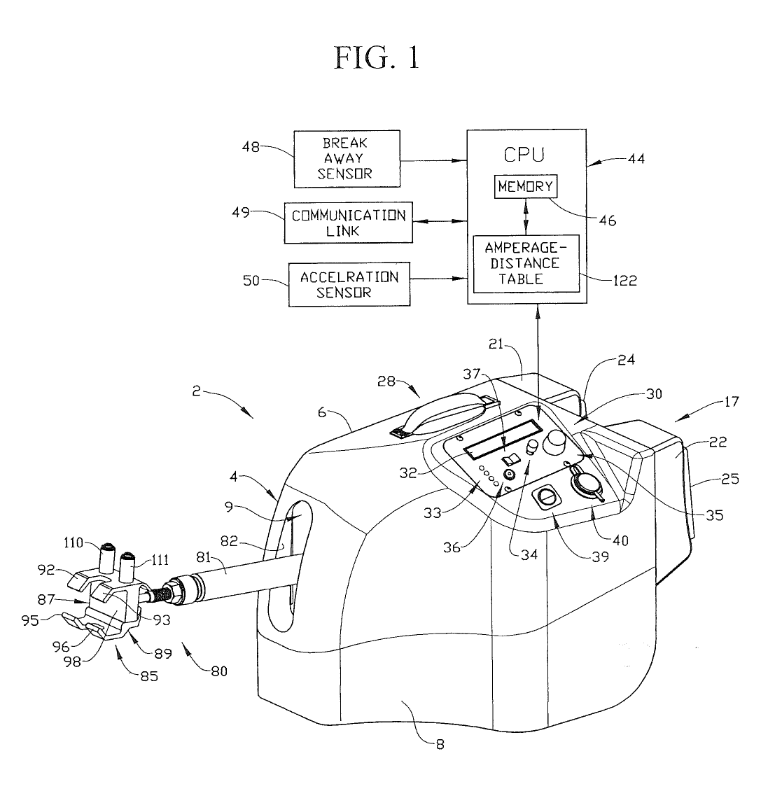

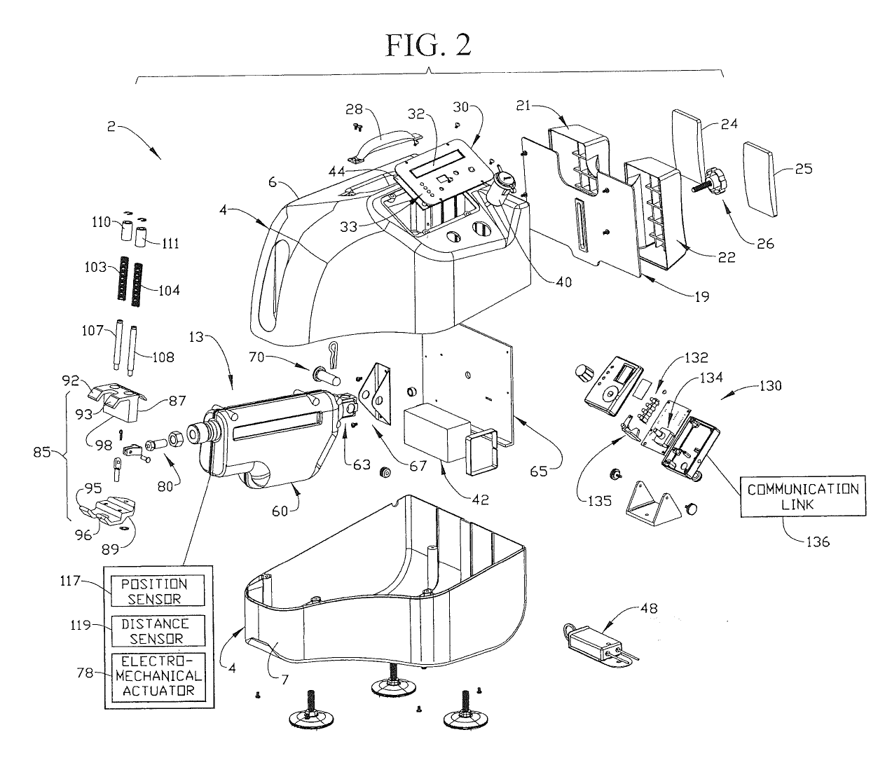

Referencing FIGS. 1 and 2 a tow brake constructed in accordance with an exemplary embodiment is indicated generally at 2. Tow brake 2 includes a housing 4 having a first or upper shell portion 6 and a second or lower shell portion 7 that collectively define a hollow interior 9 which houses an actuating mechanism 13. Housing 4 is further shown to include a towed vehicle mounting portion 17 that is secured to first and second shell portions 6 and 7 through an adjustable mounting plate 19. Towed vehicle mounting portion 17 includes a pair of mounting members 21 and 22 each having a respective pad element 24, and 25 which, as will be discussed more fully below, are configured and disposed to engage a vehicle seat when mounting tow brake 2 within a towed vehicle. Towed vehicle mounting portion 17 includes an adjustment knob 26 that enables shifting of first and second mounting members 21 and 22 relative to housing 4 in order to accommodate a variety of towed vehicle seat configurations. Tow brake 2 is also shown to include a handle 28 that aids installation and removal from the towed vehicle as well as transport of tow brake 2. In the exemplary embodiment shown, handle 28 is positioned at or near the center-of-gravity (COG) to facilitate lifting and carrying tow brake 2 with one hand.

Tow brake 2 is also shown to include a control panel 30 having a display 32, a plurality of indicator lights 33, a set-up control 34, a gain control 35, a communication port 36 and a jog switch 37. A power switch 39 is mounted to upper shell portion 6 adjacent control panel 30, as is a 12-volt plug 40 that is operatively coupled to a battery 42 and employed in connection with providing auxiliary and/or charging power to tow brake 2. Battery 42 provides a back up power supply in case the towed vehicle battery is low. In such a case, tow brake 2 will provide a warning to the user, provide enough power to function in a break away condition, and allow the unit to operate in a low power condition or be shut down. Control panel 30 further includes a controller 44 having a memory 46 that is operatively coupled to a break away sensor 48, a communication link 49 and an acceleration sensor 50 in a manner that will be detailed more fully below. In accordance with an exemplary embodiment, acceleration sensor 50 takes the form of a multi-axis digital accelerometer, however other forms of acceleration sensors such as single-axis, solid-state and analog sensors can also be employed in connection with the exemplary embodiment.

As best shown in FIG. 2, actuator mechanism 13 includes an actuator housing 60 having a mounting element 63 protruding from an end thereof. Mounting element 63 serves to secure actuator mechanism 13 to a mounting plate 65 via a bracket 67. Actuator mechanism 13 is secured to bracket 67 via pin 70. Pin 70 enables pivoting of actuator mechanism 13 relative to housing 4 in order to accommodate various vehicle geometries. Further shown in FIG. 2, actuator mechanism 13 includes an electromechanical system 78 that is operatively coupled to an actuator member 80. Actuator member 80 includes a rod member 81 that extends through an opening 82 formed in upper shell portion 6. Actuator member 80 terminates in a clamp element 85, which, as will be detailed more fully below, is configured to engage with a brake pedal (not shown) of a towed vehicle.

In accordance with the exemplary embodiment, clamp element 85 includes a first extruded jaw section 87 operatively coupled to a second extruded jaw section 89. First and second extruded jaws sections 87 and 89 are formed from an extruded material such as, aluminum, in order to achieve a desired shape in a cost effective manner. In any event, each extruded jaw section 87 and 89 includes a corresponding pair of gripping fingers 92, 93 and 95, 96 that are configured to grip a brake pedal of a motor vehicle. In the exemplary embodiment shown, first jaw section 87 includes a spring housing 98 that houses a pair of compression springs 103 and 104 that are arranged to provide a clamping force for clamp element 85. Spring housing 98 encapsulates compression springs 103 and 104 to prevent inadvertent access by fingers, or other foreign objects that may be caught within clamp element 85. In any event, compression springs 103 and 104 are supported by a pair of corresponding support rods 107 and 108 and terminate in a pair of spacers 110 and 111. With this arrangement, first and second extruded jaw sections 87 and 89 can be spread open, placed over a brake pedal, and allowed to close by a compression force provided by compression springs 103 and 104.

In accordance with the exemplary embodiment, actuator mechanism 13 includes a position sensor 117 and a distance sensor 119 which, as will be discussed more fully below, determine a position of actuator member 80 relative to actuator housing 60. In this manner, controller 44 activates actuation mechanism 13 to extend/retract actuator member 80 to apply a braking force to a brake pedal of a towed vehicle in response to acceleration forces of a towing vehicle. Of particular note, controller 44 is configured to activate actuator mechanism 13 to apply a proportional and progressive force to a brake pedal in order to mimic decelerations of a towing vehicle in a manner that will be described more fully below. In order to achieve the progressive and proportional force application, tow brake 2 includes an initial set-up mode that will be more detailed fully below.

After installing tow brake 2 within a towed vehicle such that mounting members 21 and 22 are supported upon a drivers seat and clamp element 85 is firmly secured to a brake pedal of the towed vehicle, tow brake 2 is placed in a set up mode. After plugging a power cord (not shown) into 12-volt outlet (also not shown), power switch 39 is placed in the “on” position. At this point, display 32 will provide a series of messages beginning with “jog” at which point the user activates jog switch 37 to move actuator member 80 out from actuator housing 60 so as to push slightly on the brake pedal. Jog switch 37 is actuated to push the brake pedal in as far as needed to activate the brake lights of the towed vehicle, then jogged to back off the brake pedal until the lights just turn off. Once in this initial set position, set-up button 34 is activated. Upon activation, controller 44 activates actuating mechanism 13 to repeatedly stroke the brake pedal until maximum amperage draw is reached. Once maximum amperage is achieved, controller 44 returns the brake pedal to the initial set position. In this manner, the set up mode determined a correlation of force (based on resultant amperage drawn) to distance traveled by the brake pedal to create an amperage-to-distance correlation table 122 that is saved within memory 46. The amperage-to-distance correlation table is derived from empirical data and converted to a formula within memory 46 to allow tow brake 2 to determine the amount of force necessary to apply to the brake pedal. In this manner, tow brake 2 determines braking pedal force without the need for additional load cells or other load measuring devices. That is, distance sensor 119 provides feedback to controller 44 that allows tow brake 2 to respond quickly to braking forces applied by a towing vehicle. That is, controller 44 activates actuating mechanism 13 to extend or retract a brake pedal to a specific point based on internal logic in order to apply a braking force to the towed vehicle that mimics a braking force of a towing vehicle based on signals from acceleration sensor 50. The distance feedback provided by distance sensor 119 also allows tow brake 2 to respond proportionally to small changes by a towing vehicle. In addition to the amperage-to-distance determination, amperage-to-distance correlation table 122 includes bench test data. The bench test data includes an average force output vs. amperage for a number of systems to further aid braking operations.

Following set-up, during travel, the brakes of the towed vehicle are applied to mimic deceleration forces of the towing vehicle. Controller 44 reads digital acceleration sensor 50 as much as 200 times per second or more. Based on input from acceleration sensor 50 controller 44 determines how much to move actuator rod 81 to apply/release the brake pedal of the towed vehicle. The continuous sensing of the deceleration/acceleration forces of the towing vehicle enables controller to apply a progressive and proportional force to the brake of the towed vehicle. As noted above, on board battery 42 in tow brake 2 acts as a back-up power supply in the event the towed vehicle's battery is too low thereby allowing continued operation of tow brake 2. In such a case, a “low battery” signal is provided to the user while tow brake 2 is provided with ample power for emergency use, for operation in a low power mode, and to enable shut down.

In addition to the above, tow brake 2 includes a control member 130 that is arranged within the towing vehicle. Control member 130 includes a plurality of indicator lights 132, a gain control 134, a manual override lever 135, and a communication link 136 that is configured to communicate with communication link 49 of tow brake 2. Tow brake 2 further includes a manual override feature that allows a user to set a desired amount of braking by manipulating manual override lever 135. That is, there exists a two-way, wireless, communication between control member 130 and controller 44. Of course other forms of communication systems including a wired link can also be employed. With this arrangement, a driver of the towing vehicle can vary the sensitivity of tow brake 2 by manipulating gain control 134. In this manner, driver can vary the sensitivity or braking power of the towed vehicle during adverse conditions, or manually override the controller 44 when conditions warrant. In addition, in the event of a loss of power resulting from a disconnect from the towing vehicle, break away sensor 48 will signal controller 44 to automatically activate the braking system of the towed vehicle and mechanically hold the brake pedal in an applied position in order to ensure that the towed vehicle does not travel far after breaking away from a towing vehicle.

At this point, it should be understood that the exemplary embodiments provide a tow brake that provides a force that mimics the braking force to a towed vehicle that is both proportional and progressive in order to mimic braking forces applied by a towing vehicle. That is, by applying a proportional and progressive force to the brake of a towed vehicle, tow brake 2 does not act as an on-off switch nor will it drag i.e., provide a partial braking when the driver of a towing vehicle backs off a vehicle brake in small increments.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A tow brake comprising:
a housing;
an actuator mechanism mounted within the housing, the actuator mechanism including an actuator member;
a towed vehicle attachment member operatively coupled to the actuator member;
a controller operatively connected to the actuator mechanism; and
an acceleration sensor operatively coupled to the controller, the acceleration sensor being configured and disposed to detect deceleration forces of a towing vehicle, wherein the controller is configured and disposed to selectively activate the actuator mechanism to apply a force to the vehicle attachment member that is proportional to the deceleration forces of the towing vehicle.

2. The tow brake according to claim 1, wherein the controller is configured and disposed to selectively activate the actuator mechanism to apply a progressive force to the vehicle attachment member.

3. The tow brake according to claim 1, further comprising: a position sensor arranged operatively coupled to the actuator member, the position sensor detecting a position of the actuator member relative to the actuator mechanism.

4. The tow brake according to claim 1, further comprising: a control member configured and disposed in the towing vehicle, the control member including a communication link with the controller.

5. The tow brake according to claim 4, wherein in the communication link is a two-way wireless link.

6. The tow brake according to claim 1, wherein the controller includes an amperage-to-force correlation table, the controller being configured and disposed to apply the force to the towed vehicle attachment member without requiring a load sensor.

7. The tow brake according to claim 1, further comprising: a clamp element mounted to the towed vehicle attachment member, the clamp element including a first extruded jaw section operatively coupled to a second extruded jaw section, the first and second extruded jaw sections being configured and disposed to fixedly secure the towed vehicle attachment member to a brake pedal of the towed vehicle.

8. The tow brake according to claim 7, further comprising: at least one compression spring arranged between the first and second jaw sections.

9. The tow brake according to claim 8, wherein at least one of the first and second jaw sections includes a spring housing, the at least one compression spring being arranged entirely within the compression spring housing.

10. The tow brake according to claim 1, further comprising: a manual override lever, the manual override lever enabling a user to establish a braking force independent of the controller.

11. The tow brake according to claim 1, further comprising: a braking force break away sensor, the break away sensor signaling the controller to activate a full break mode in the event that the towed vehicle detaches from the towing vehicle.

12. A method of braking a towed vehicle based on acceleration forces of a towing vehicle, the method comprising:
detecting a deceleration force of a towing vehicle;
determining a rate of deceleration of the towing vehicle; and
activating an actuator mechanism to cause an actuation member to apply a braking force proportional to the rate of deceleration of the towing vehicle to a brake pedal in the towed vehicle.

13. The method of claim 12, further comprising: activating the actuating member to apply a progressive force to the brake pedal in the towed vehicle.

14. The method of claim 12, determining a force to apply to the brake pedal in towed vehicle based on a correlation between amperage required for a particular force and a force required to achieve the braking force proportional to the rate of deceleration of the towing vehicle.

15. The method of claim 12, further comprising: extending the actuating member a predetermined distance to apply a required force and retracting the actuating member another predetermined distance to release the required force based upon feedback from a distance sensor.

16. The method of claim 12, further comprising: varying braking sensitivity of the tow brake from the towing vehicle.

17. The method of claim 12, further comprising: performing an initial set-up of the tow brake, the initial set-up determining how far the actuating member must move the brake pedal to achieve a desired braking force.

18. The method according to claim 17, further comprising: activating the actuator mechanism to repeatedly pump the brake pedal during the initial set-up.

19. The method according to claim 18, further comprising: creating an amperage-to-distance correlation table based on pumping the brake pedal, the amperage-to-distance correlation table defining the amount of force to applied to the brake pedal without the need for a load sensor.

20. The method of claim 12, further comprising: communicating between a control member in the towing vehicle and a controller in the tow brake.

21. The method of claim 12, further comprising: automatically applying a full brake force upon sensing that the towed vehicle has separated from the towing vehicle.
